(19) United States
(12) Patent Application Publication
(10) Pub. No.: US 2020/0226919 A1
(43) Pub. Date: Jul. 16, 2020

(54) WRISTBAND CONTROLLER

(71) Applicant: Switch Project, LLC, Woodland Hills, CA (US)

(72) Inventor: Ben Salem, Woodland Hills, CA (US)

(73) Assignee: Switch Project, LLC

(21) Appl. No.: 16/741,550

(22) Filed: Jan. 13, 2020

Related U.S. Application Data
(60) Provisional application No. 62/792,280, filed on Jan. 14, 2019.
(60) Provisional application No. 62/885,737, filed on Aug. 12, 2019.

(51) Int. Cl. G08C 17/02; H04N 5/232

(52) U.S. Cl. CPC G08C 17/02; H04N 5/23203; G08C 2201/31; G08C 2201/10; G08C 2201/93

(57) ABSTRACT

A wearable remote control device communicates with a remotely located electronic device. The remote control device comprises a remote control body and a remote control face. The remote control device comprises a first pressable control button located within a center of the body and one or more additional pressable control buttons arranged in a circle around an outside of the first pressable button. In some embodiments, the wearable remote control device has a strap for securing the wearable remote control device to an appendage of a user.

### RELATED APPLICATIONS

This patent application claims priority under 35 U.S.C. 119(e) of the co-pending U.S. provisional patent applications, Application No. 62/792,280, filed on Jan. 14, 2019, and entitled “WRISTBAND CONTROLLER,” and Application No. 62/885,737, filed on Aug. 12, 2019, and entitled “WRISTBAND CONTROLLER,” which are both hereby incorporated by reference in their entirety.

### FIELD OF THE INVENTION

The present invention is generally directed to devices, systems and methods for remotely controlling an electronic device. More specifically, the present invention is directed to a device, system and method that is configured to conveniently wrap around a wrist or other appendage of a user and is used to control a remotely located electronic device.

### BACKGROUND OF THE INVENTION

Portable electronic and smart devices allow users access and to control music and media devices and receive and send telephone calls wherever they go. Often the electronic device will be placed in a user's pocket or some other remote location where the electronic and/or smart device will not be damaged as the user moves around. In order to control the electronic device it is then necessary to retrieve the electronic device from this remote location to allow the user to physically access the electronic device.

### SUMMARY OF THE INVENTION

A wearable remote control device communicates with a remotely located electronic device. The remote control device comprises a remote control body and a remote control face. The remote control device comprises a first pressable control button located within a center of the body and one or more additional pressable control buttons arranged in a circle around an outside of the first pressable button. In some embodiments, the wearable remote control device has a strap for securing the wearable remote control device to an appendage of a user.

In a first aspect, a wearable remote control device for communicating with a remotely located electronic device comprises a substantially circular remote control body comprising a remote control face comprising a first pressable control button located within a center of the body and one or more additional pressable control buttons arranged in a circle around an outside of the first pressable button and an attachment mechanism for removably coupling the remote control device with an appendage of a user. In some embodiments, the attachment mechanism comprises a strap for securing the wearable remote control device to the appendage of a user. In some embodiments, the attachment mechanism comprises a wearable body comprising a cavity for removably receiving the remote control body. In further embodiments, the attachment mechanism comprises one of a carabineer, a lanyard, a key ring and a clip. In some embodiments, the first pressable button and the one or more additional pressable buttons each comprise separately pressable mechanical buttons. In some embodiments, the remotely located electronic device comprises one or more of a smart phone, a media player, a video camera, and a set of earphones. In some embodiments, the first pressable button and the one or more additional pressable buttons comprise one or more of a start/pause control, a volume control and a track control. In further embodiments, one or more of the first pressable button and the one or more additional pressable buttons send a signal to the remotely located electronic device to take a picture, start and stop recording video. In still further embodiments, one or more of the first pressable button and the one or more additional pressable buttons answers and terminates a phone call from the remotely located electronic device. In some embodiments, one or more of the first pressable button and the one or more additional pressable buttons communicate with an application stored on a memory of the remotely located electronic device. In some embodiments, the remote control device comprises a pullable button that activates an alert which sends a location from the application stored on a memory of the remotely located electronic device indicating a location of the wearable remote control device. In some embodiments, one or more of the first pressable button and the one or more additional pressable buttons is pressed and held to activate a microphone for receiving voice commands. In further embodiments, one or more of the first pressable button and the one or more additional pressable buttons is pressed to activate a virtual assistant connected to the remotely located electronic device. In some embodiments, the device is charged using one of a micro-usb cable and a usb cable. In further embodiments, the remote control device is wirelessly charged. In some embodiments, the remote control device comprises a battery with a thickness of 2.5 mm or less. In some embodiments, one or more electronic components of a circuit board of the remote control device are embedded into and flush with the circuit board and surround the battery of the remote control device. In some embodiments, the remote control device comprises a layer of electric and electromagnetic radiation shielding. In some embodiments, the remote control device is usable with headphones comprising a layer of electric and electromagnetic radiation shielding.

In a further aspect, a wearable system for communicating with a remotely located electronic device comprises a substantially circular body comprising a first pressable control button located within a center of the body and one or more additional pressable control buttons arranged in a circle around an outside of the first pressable button, wherein one or more of the first pressable button and the one or more additional pressable buttons communicate with an application stored on a memory of the remotely located electronic device and a microphone for receiving voice commands for sending a voice command to the remotely located electronic device, a left side strap coupled to the body and a right side strap coupled to the body, wherein the left side strap and the right side strap fasten to couple the system with an appendage of a user. In some embodiments, the first pressable button and the one or more additional pressable buttons each comprise separately pressable mechanical buttons. In some embodiments, the remotely located electronic device comprises one or more of a smart phone, a media player, a video camera, and a set of earphones. In some embodiments, the first pressable button and the one or more additional pressable buttons comprise one or more of a start/pause control, a volume control and a track control. In further embodiments, one or more of the first pressable button and the one or more additional pressable buttons send a signal to the remotely located electronic device to take a picture, start and stop recording video. In still further embodiments, one or more of the first pressable button and the one or more additional pressable buttons answers and terminates a phone call from the remotely located electronic device. In some embodiments, the substantially circular body comprises a pullable button that activates an alert which sends a location from the application stored on a memory of the remotely located electronic device indicating a location of the wearable remote control device. In some embodiments, one or more of the first pressable button and the one or more additional pressable buttons is pressed and held to activate the microphone for receiving voice commands. In some embodiments, one or more of the first pressable button and the one or more additional pressable buttons is pressed to activate a virtual assistant connected to the remotely located electronic device.

In another aspect, a method of utilizing a wearable remote control device for communicating with a remotely located electronic device comprises attaching a left side strap to a substantially circular body of the wearable remote control device, attaching a right side strap to the substantially circular body of the wearable remote control device, coupling the wearable remote control device with an appendage of a user and pressing one or more tactile control buttons of the body to communicate with an application stored on a memory of the remotely located electronic device. In some embodiments, the remotely located electronic device comprises one or more of a smart phone, a media player, a video camera and a set of earphones. In some embodiments, the one or more tactile control buttons comprise one or more of a start/pause control, a volume control and a track control. In further embodiments, the one or more tactile control buttons send a signal to the remotely located electronic device to take a picture, start and stop recording video. In some embodiments, pressing one or the one or more tactile control buttons activates a microphone for receiving voice commands.

In still a further aspect, a wearable remote control device for communicating with a remotely located electronic device comprises a control body comprising a remote control face comprising a plurality of pressable buttons, a battery comprising a thickness of less than or equal to 2.5 mm and a circuit board comprising one or more electronic components embedded into and flush with the circuit board and that surround the battery. In some embodiments, the remote control device comprises a layer of electric and electromagnetic radiation shielding. In some embodiments, one or more of the plurality of pressable buttons communicates with an application stored on a memory of the remotely located electronic device. In some embodiments, the remote control device comprises a pullable button that activates an alert which sends a location from the application stored on a memory of the remotely located electronic device indicating a location of the wearable remote control device.

### BRIEF DESCRIPTION OF THE DRAWINGS

Several example embodiments are described with reference to the drawings, wherein like components are provided with like reference numerals. The example embodiments are intended to illustrate, but not to limit, the invention. The drawings include the following figures:

FIG. 1 illustrates a wearable remote control device, in accordance with some embodiments.

FIG. 2 illustrates a wearable system for communicating with a remotely located electronic device, in accordance with some embodiments.

FIG. 3 illustrates a wearable system for communicating with a remotely located electronic device, in accordance with some embodiments.

FIG. 4 illustrates a method of utilizing a wearable remote control device, in accordance with some embodiments.

FIGS. 5A-5C illustrate a remote control device and system, in accordance with some embodiments.

FIGS. 6A-6C illustrate a remote control device and system, in accordance with some embodiments.

FIG. 7 illustrates a remote control device and system, in accordance with some embodiments.

FIG. 8 illustrates a remote control device and system, in accordance with some embodiments.

FIG. 9 illustrates an exploded view of a remote control device, in accordance with some embodiments.

FIG. 10 illustrates an exploded view of a remote control device and system, in accordance with some embodiments.

FIG. 11 illustrates a remote control device and system, in accordance with some embodiments.

FIG. 12 illustrates a remote control device and system, in accordance with some embodiments.

FIG. 13 illustrates a remote control device and system, in accordance with some embodiments.

FIG. 14 illustrates a remote control device and system, in accordance with some embodiments.

FIGS. 15A and 15B illustrate an electronic device controller, in accordance with some embodiments.

FIG. 16A-16C illustrate a remote control device and system, in accordance with some embodiments.

FIG. 17 illustrates a remote control device and system, in accordance with some embodiments.

FIG. 18 illustrates a remote control device and system, in accordance with some embodiments.

FIG. 19 illustrates a remote control device and system, in accordance with some embodiments.

FIG. 20 illustrates a remote control device and system, in accordance with some embodiments.

FIG. 21 illustrates a method of utilizing a remote control, in accordance with some embodiments.

FIG. 22 illustrates a remote control device and system, in accordance with some embodiments.

FIGS. 23A-23C illustrate an electronic device controller, in accordance with some embodiments.

### DETAILED DESCRIPTION OF THE EMBODIMENTS

Embodiments of the wristband controller are directed to wearable remote control device that communicates with a remotely located electronic device. The remote control device comprises a remote control body and a remote control face. The remote control device comprises a first pressable control button located within a center of the body and one or more additional pressable control buttons arranged in a circle around an outside of the first pressable button. In some embodiments, the wearable remote control device has a strap for securing the wearable remote control device to an appendage of a user.

Reference will now be made in detail to implementations of a wearable remote control device and system as illustrated in the accompanying drawings. The same reference indicators will be used throughout the drawings and the following detailed description to refer to the same or like parts. In the interest of clarity, not all of the routine features of the implementations described herein are shown and described. It will be appreciated that in the development of any such actual implementation, numerous implementation-specific decisions can be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

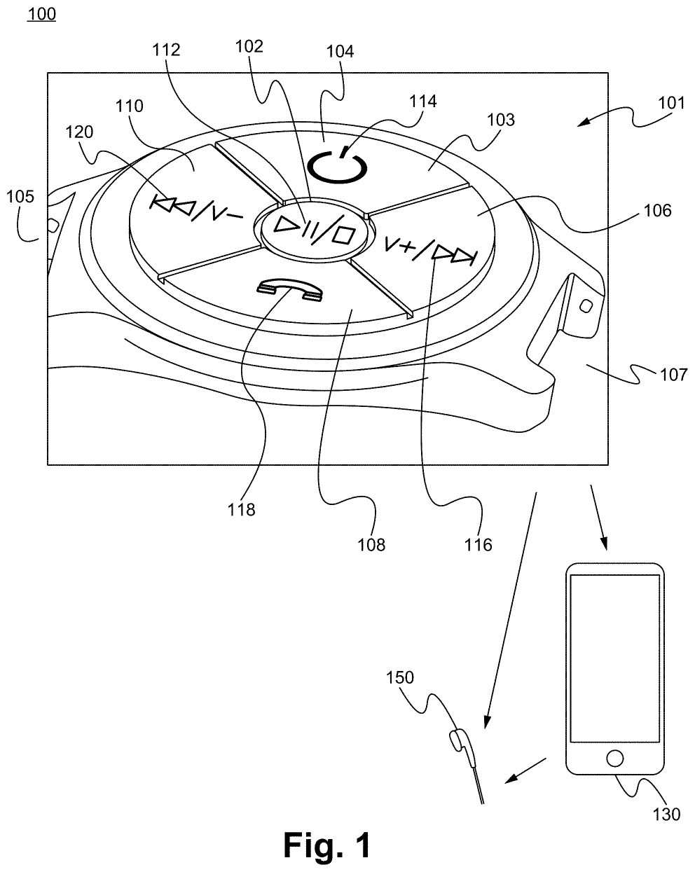

Referring now to FIG. 1, a wearable remote control device 100 is depicted therein. The wearable remote control device 100 is configured to communicate with a remotely located electronic device 130 and 150.

As shown within FIG. 1, the remote control device 100 comprises a substantially circular remote control body 101. In some embodiments, the remote control body 101 comprises a remote control face 103. The remote control face 103 comprises a first pressable control button 102 located within a center of the remote control face 103 and one or more additional pressable control buttons arranged in a circle around an outside of the first pressable control button 102. In some embodiments, the remote control face 103 comprises four additional pressable control buttons 104, 106, 108 and 110 equally spaced and arranged in a circle around an outside of the first pressable control button 102. However, the face of the remote control device 100 is able to comprise any appropriately desired number of pressable control buttons for communicating with a remotely located electronic device. Additionally, although a substantially circular body 101 is shown within FIG. 1, the body 101 is able to comprise any appropriately desired shape. For example, in some embodiments, the body 101 is square or rectangular shaped.

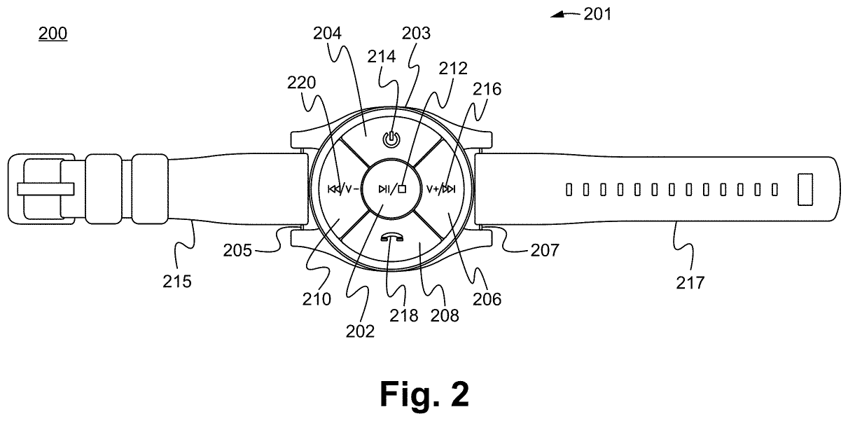

As further shown in FIG. 1, in some embodiments, the remote control body 101 comprises a left side lug set 105 and a right side lug set 107. In some embodiments, the left side lug set 105 and the right side lug set 107 are used to couple the remote control body 101 with a strap for securing body 101 around an appendage of a user. In some embodiments, such as shown in FIG. 2, the strap comprise a left side strap and a right side strap. However, the strap is able to comprise any appropriately desired strap for securing the wearable remote control device 100 with an appendage of the user.

In some embodiments, the pressable buttons of the remote control face 103 each comprise separately clickably or pressable tactile or mechanical buttons. However, the pressable buttons of the remote control face 103 are able to comprise any appropriately desired separately clickable buttons. In some embodiments, the body 101 and the remote control face 103 comprises a rubber and/or a rubberized material. As further shown within FIG. 1, in some embodiments, the first pressable control button 102 and the one or more additional pressable control buttons each comprise a raised shape that is raised from the remote control face 103 that indicate a function of each button. For example, the center control button 102 comprises a raised shape 112 that indicates the center control button 102 plays, pauses or stops the remote control device 100 and/or the remotely located electronic device 130 and the set of earphones 150. Additionally, in some embodiments, the pressable button 104 comprises a raised shape 114 that powers on the remote control device 100 and/or the remotely located electronic device 130 and the set of earphones 150, the pressable button 106 comprises a raised shape 116 that indicates the button is a track forward or volume up button, the pressable button 108 comprises a raised shape 118 that indicates the button answers a phone call and the pressable button 110 comprises a raised shape 120 that indicates the button is a track backward or volume down button. Alternatively, in some embodiments, the first pressable control button 102 and the one or more additional pressable control buttons each comprise an impression indented into the remote control face 103 that indicate a function of each button, such as described above.

In some embodiments, the pressable buttons of the remote control face 103 comprise one or more of a start/pause control, a volume up control, a volume down control, a track forward button and a track backward button. In some embodiments, the pressable buttons of the remote control face 103 enable a user to control media and/or other music being played through a set of earphones 150 connected to the remotely located electronic device 130. In some embodiments, the pressable buttons of the remote control face 103 are configured to directly control the set of earphones 150. The set of earphones 150 are able to connect to the remotely located electronic device 130 using a wired and/or wireless or true wireless connection. In some embodiments, the remote control device 100 is wirelessly connected to the remotely located electronic device 130 and/or the set of earphones 150. However, the remote control device 100 is able to connect to the remotely located electronic device 130 and the set of earphones 150 in any appropriately desired manner.

In some embodiments, simultaneously pressing a plurality of buttons of the electronic the remote control device 100 enables the remote control device 100 to perform additional functions. For example, in some embodiments, simultaneously pressing two buttons of the remote control device 100 sends a signal to the remotely located electronic device 130 to take a photo. In some embodiments, simultaneously pressing two buttons of the remote control device 100 sends a signal to the remotely located electronic device 130 to begin recording video. In some embodiments, recording can be stopped by simultaneously pressing the same two buttons of the remote control device 100 to send a signal to the remotely located electronic device 130 to stop recording video. Particularly, the remote control device 100 is able to be programmed to perform any appropriately desired function for controlling the remotely located electronic device 130 and/or the set of earphones 150. In some embodiments, the electronic device 130 comprises a smart phone or media player. In some embodiments, the electronic device 130 comprises a personal video camera. However, the electronic device 130 is able to comprise any appropriately desired electronic device.

In further embodiments, such as shown in FIG. 1, the remote control device 100 comprises a microphone 140. In some embodiments, pressing and holding one or more of the pressable control buttons activates the microphone for receiving voice commands. For example, in some embodiments, pressing and holding the center button 102 activates the microphone to receive voice commands. Consequently, a user is able to then control the remotely located electronic device, such as described above, using voice commands. In some embodiments, pressing and holding one or more of the pressable control buttons activates the microphone so that the user is able to activate a virtual assistant connected to the remotely located electronic device 130. For example, a button of the remote control device 100 is able to be pressed and held to communicate with a virtual assistant such as Apple Siri®, Google Assistant®, Microsoft Cortana®, Amazon Alexa®, Samsung Bixby® or other similar virtual assistant.

FIG. 2 illustrates a wearable system for communicating with a remotely located electronic device. The wearable remote control device 200 is configured to communicate with a remotely located electronic device 130 and 150 (FIG. 1), such as described above.

As shown within FIG. 2, the system 200 comprises a substantially circular body 201. In some embodiments, the remote control body 201 comprises a remote control face 203. As described above, the remote control face 203 comprises a first pressable control button 202 located within a center of the remote control face 203 and one or more additional pressable control buttons arranged in a circle around an outside of the first pressable control button 202. In some embodiments, the remote control face 203 comprises four additional pressable control buttons 204, 206, 208 and 210 equally spaced and arranged in a circle around an outside of the first pressable control button 202. However, the face of the remote control device 200 is able to comprise any appropriately desired number of pressable control buttons for communicating with a remotely located electronic device. As further shown within FIG. 2, the system 200 comprises a left side strap 215 coupled to a left side of the body 201 and a right side strap 217 coupled to a right side of the body 201. In some embodiments, the remote control body 201 comprises a left side lug set 205 for coupling the left side strap 215 to a left side of the body 201 and a right side lug set 207 for coupling the right side strap 217 to a right side of the body 201. As described above, although a substantially circular body 201 is shown, the body 201 is able to comprise any appropriately desired shape. For example, in some embodiments, the body 201 is square or rectangular shaped.

As described above, in relation to the FIG. 1, in some embodiments, the pressable buttons of the remote control face 203 and the body 201 each comprise separately clickably or pressable tactile or mechanical buttons. However, the pressable buttons of the remote control face 203 are able to comprise any appropriately desired separately clickable buttons. In some embodiments, the body 201 and the remote control face 203 comprises a rubber and/or a rubberized material. As further shown within FIG. 2, in some embodiments, the first pressable control button 202 and the one or more additional pressable control buttons each comprise a raised shape that is raised from the remote control face 203 that indicate a function of each button. For example, the center control button 202 comprises a raised shape 212 that indicates the center control button 202 plays, pauses or stops the remote control device 200 and/or the remotely located electronic device and the set of earphones (FIG. 1). Additionally, in some embodiments, the pressable button 204 comprises a raised shape 214 that indicates the button that powers on the remote control device 100 and/or the remotely located electronic device 130 and the set of earphones 150, the pressable button 206 comprises a raised shape 216 that indicates the button is a track forward or volume up button, the pressable button 208 comprises a raised shape 218 that indicates the button answers a phone call and the pressable button 210 comprises a raised shape 220 that indicates the button is a track backward or volume down button. Alternatively, in some embodiments, the first pressable control button 202 and the one or more additional pressable control buttons each comprise an impression indented into the remote control face 203 that indicate a function of each button, such as described above.

In some embodiments, the pressable buttons of the remote control face 203 comprise one or more of a start/pause control, a volume up control, a volume down control, a track forward button and a track backward button. In some embodiments, the pressable buttons of the remote control face 203 enable a user to control media and/or other music being played through a set of earphones connected to the remotely located electronic device. In some embodiments, the pressable buttons of the remote control face 203 are configured to directly control the set of earphones. The set of earphones are able to connect to the remotely located electronic device using a wired and/or wireless connection. In some embodiments, the system 200 is wirelessly connected to the remotely located electronic device and/or the set of earphones. However, the system 200 is able to connect to the remotely located electronic device and the set of earphones in any appropriately desired manner.

As described above, in some embodiments, simultaneously pressing a plurality of buttons of the electronic the system 200 enables the system 200 to perform additional functions. For example, in some embodiments, simultaneously pressing two buttons of the system 200 sends a signal to the remotely located electronic device to take a photo. In some embodiments, simultaneously pressing two buttons of the system 200 sends a signal to the remotely located electronic device to begin recording video. In some embodiments, recording can be stopped by simultaneously pressing the same two buttons of the system 200 to send a signal to the remotely located electronic device to stop recording video. Particularly, the system 200 is able to be programmed to perform any appropriately desired function for controlling the remotely located electronic device and/or the set of earphones. In some embodiments, the system 200 comprises a smart phone or media player. In some embodiments, the electronic device comprises a personal video camera. However, the electronic device is able to comprise any appropriately desired electronic device.

As described above, the remote control device 200 comprises a microphone 240. In some embodiments, pressing and holding one or more of the pressable control buttons activates the microphone for receiving voice commands. For example, in some embodiments, pressing and holding the center button 202 activates the microphone to receive voice commands.

Consequently, a user is able to then control the remotely located electronic device, such as described above, using voice commands. In some embodiments, pressing and holding one or more of the pressable control buttons activates the microphone so that the user is able to activate a virtual assistant connected to the remotely located electronic device (FIG. 1). For example, a button of the remote control device 200 is able to be pressed and held to communicate with a virtual assistant such as Apple Siri®, Google Assistant®, Microsoft Cortana®, Amazon Alexa®, Samsung Bixby® or other similar virtual assistant.

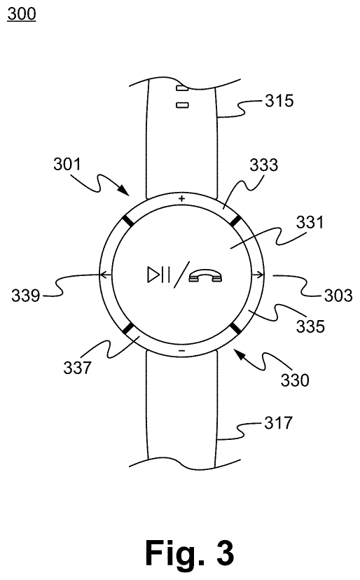

FIG. 3 illustrates a wearable system for communicating with a remotely located electronic device. The wearable remote control device 300 is configured to communicate with a remotely located electronic device 130 and 150 (FIG. 1), such as described above.

As shown within FIG. 3, the system 300 comprises a substantially circular body 301. In some embodiments, the remote control body 301 comprises a remote control face 303. As shown within FIG. 3, the body 301 comprises a middle pressable control button 331 and one or more outside pressable control buttons arranged in a circle around an outside of the middle pressable control button 331 and within an exterior ring 330 of the remote control face 303 and body 301. In some embodiments, the remote control face 303 comprises four outside pressable control buttons 333, 335, 337 and 339 equally spaced and arranged in a circle around an outside of the middle pressable control button 331. However, the face 303 of the remote control device 300 is able to comprise any appropriately desired number of pressable control buttons for communicating with a remotely located electronic device. As further shown within FIG. 3, the system 300 comprises a left side strap 315 coupled to a left side of the body 301 and a right side strap 317 coupled to a right side of the body 301. In some embodiments, the remote control body 301 comprises a left side lug set for coupling the left side strap 315 to a left side of the body 301 and a right side lug set for coupling the right side strap 317 to a right side of the body 301, such as described above. As described above, the body 301 is able to comprise any appropriately desired shape. For example, in some embodiments, the body 301 is square or rectangular shaped.

As described above, in relation to the FIGS. 1 and 2, in some embodiments, the pressable buttons of the remote control face 303 and the body 301 each comprise separately clickably or pressable tactile or mechanical buttons. However, the pressable buttons of the remote control face 303 are able to comprise any appropriately desired separately clickable buttons. In some embodiments, the body 301 and the remote control face 303 comprises a rubber and/or a rubberized material.

As further shown within FIG. 3, in some embodiments, the middle pressable control button 331 and the one or more outside pressable control buttons each comprise a raised shape that is raised from the remote control face 303 that indicate a function of each button, such as described above. Alternatively, in some embodiments, the middle pressable control button 331 and the one or more outside pressable control buttons each comprise an impression indented into the remote control face 303 that indicate a function of each button, such as described above.

In some embodiments, the pressable buttons of the remote control face 303 comprise one or more of a start/pause control, a volume up control, a volume down control, a track forward button and a track backward button. In some embodiments, the pressable buttons of the remote control face 303 enable a user to control media and/or other music being played through a set of earphones connected to the remotely located electronic device. In some embodiments, the pressable buttons of the remote control face 303 are configured to directly control the set of earphones. The set of earphones are able to connect to the remotely located electronic device using a wired and/or wireless connection. In some embodiments, the system 300 is wirelessly connected to the remotely located electronic device and/or the set of earphones. However, the system 300 is able to connect to the remotely located electronic device and the set of earphones in any appropriately desired manner.

As described above, in some embodiments, simultaneously pressing a plurality of buttons of the electronic the system 300 enables the system 300 to perform additional functions. For example, in some embodiments, simultaneously pressing two buttons of the system 300 sends a signal to the remotely located electronic device to take a photo. In some embodiments, simultaneously pressing two buttons of the system 300 sends a signal to the remotely located electronic device to begin recording video. In some embodiments, recording can be stopped by simultaneously pressing the same two buttons of the system 300 to send a signal to the remotely located electronic device to stop recording video. Particularly, the system 300 is able to be programmed to perform any appropriately desired function for controlling the remotely located electronic device and/or the set of earphones. In some embodiments, the system 300 comprises a smart phone or media player. In some embodiments, the electronic device comprises a personal video camera. However, the electronic device is able to comprise any appropriately desired electronic device.

In some embodiments, the devices and systems, such as described above comprises an appropriately desired waterproof and/or wind-proof case protect against the outside elements. Particularly, the devices and systems are able to be used in an open environment when the remotely located electronic device is placed within a pocket and other secure location. Additionally, because in some embodiments the devices and systems use mechanically clickable buttons, the devices and systems are able to be used while the user is wearing gloves and are easily pushed and manipulated by a user.

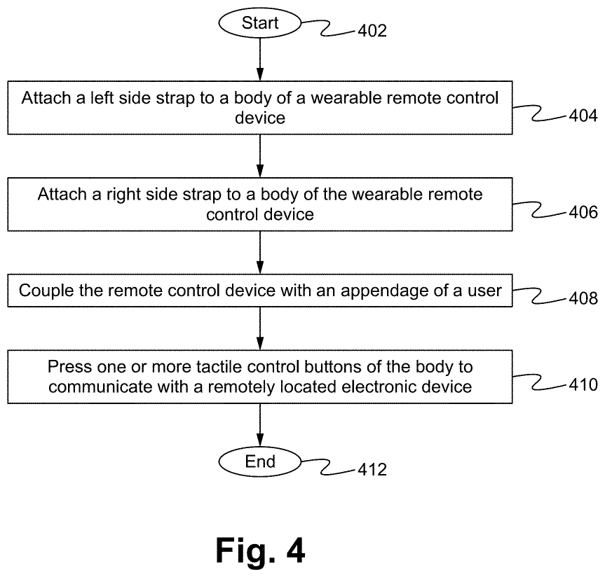

FIG. 4 illustrates a method of utilizing a remote control in accordance to some embodiments. In some embodiments, the remote control comprises a remote control device and system, such as described above. The method begins in the step 402. In the step 404, a left side strap is attached to a substantially circular body of the wearable remote control device. In the step 406, a right side strap is attached to the substantially circular body of the wearable remote control device. Then in the step 408, the wearable remote control device is coupled with an appendage of a user and in the step 410 one or more tactile control buttons of the body are pressed to communicate with the remotely located electronic device. The method ends in the step 412.

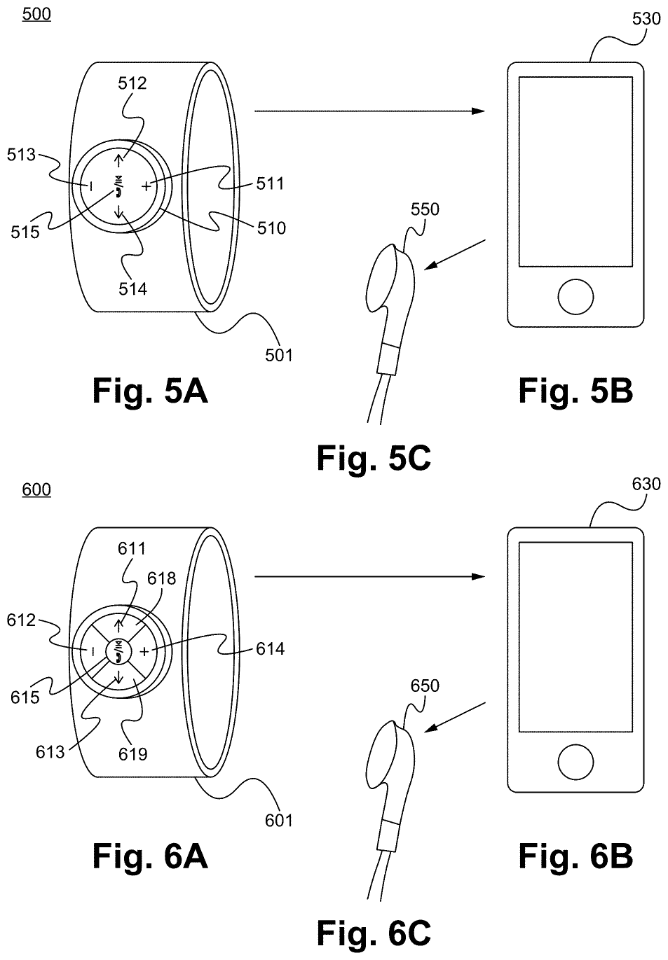

Referring now to FIGS. 5A-5C, a remote control device and system is depicted therein. The remote control device and system 500 enables a band mounted electronic device controller to control a remotely located electronic device. As shown within FIG. 5A, the device and system comprises a body 501 comprising a circular wrap. The body 501 comprising a circular wrap is configured to continuously wrap around an entire circumference of a user. For example, in some embodiments, the body 501 is configured to wrap around a wrist and/or an arm of a user. However, the body 501 is able to wrap around any appropriately desired appendage such as a leg, calf or other appendage. An electronic device controller 510 is embedded within and/or removably coupled to the body 501. The electronic device controller 510 is configured to communicate with and/or control a remotely located electronic device 530, such as shown within FIG. 5B. In some embodiments, the electronic device 530 comprises a smart phone or media player. In some embodiments, the electronic device 530 comprises a personal video camera. However, the electronic device 530 is able to comprise any appropriately desired electronic device.

In some embodiments, the electronic device controller 510 comprises one or more controls for controlling the remotely located electronic device 530. For example, in some embodiments, the electronic device controller 510 comprises a start/pause control 515, a volume up control 511, a volume down control 513, a track forward button 512 and a track backward button 514. Particularly, in some embodiments, the controller 510 enables a user to control media and/or other music being played through a set of earphones 550 connected to the remotely located electronic device 530. The set of earphones 550 are able to connect to the remotely located electronic device 530 using a wired and/or wireless connection. In some embodiments, the electronic device controller 510 is wirelessly connected to the remotely located electronic device 530. However, the electronic device controller 510 is able to connect to the remotely located electronic device 530 in any appropriately desired manner.

In some embodiments, simultaneously pressing a plurality of buttons of the electronic device controller 510 enables the controller 510 to perform additional functions. For example, in some embodiments, simultaneously pressing two buttons of the controller 510 sends a signal to the remotely located electronic device 530 to take a photo. In some embodiments, simultaneously pressing two buttons of the controller 510 sends a signal to the remotely located electronic device 530 to begin recording video. In some embodiments, the controller 510 comprises a light which indicates that the remotely located electronic device 530 is recording a video. In some embodiments, recording can be stopped by simultaneously pressing the same two buttons of the controller 510 to send a signal to the remotely located electronic device 530 to stop recording video. Particularly, the controller 510 is able to be programmed to perform any appropriately desired function for controlling the remotely located electronic device.

Referring now to FIGS. 6A-6C, a remote control device and system is depicted therein. The remote control device and system 600 enables a band mounted electronic device controller to control a remotely located electronic device. As shown within FIG. 6A, the device and system comprises a body 601 comprising a circular wrap. The body 601 comprising a circular wrap is configured to continuously wrap around an entire circumference of a user. For example, in some embodiments, the body 601 is configured to wrap around a wrist and/or an arm of a user. However, the body 601 is able to wrap around any appropriately desired appendage such as a leg, calf or other appendage. An electronic device controller 610 is embedded within and/or removably coupled to the body 601. The electronic device controller 610 is configured to communicate with and/or control a remotely located electronic device 630, such as shown within FIG. 6B. In some embodiments, the electronic device 630 comprises a smart phone or media player. In some embodiments, the electronic device 630 comprises a personal video camera. However, the electronic device 630 is able to comprise any appropriately desired electronic device.

In some embodiments, the electronic device controller 610 comprises one or more controls for controlling the remotely located electronic device 630. For example, in some embodiments, the electronic device controller 610 comprises a start/pause control 615, a power on/off button 611, a phone control button 613, a speaker 619, a track forward button 612 and a track backward button 615. Particularly, in some embodiments, the controller 610 enables a user to control media and/or other music being played through a set of earphones 650 connected to the remotely located electronic device 630. The set of earphones 650 are able to connect to the remotely located electronic device 630 using a wired and/or wireless connection. In some embodiments, the electronic device controller 610 is wirelessly connected to the remotely located electronic device 630. However, the electronic device controller 610 is able to connect to the remotely located electronic device 630 in any appropriately desired manner.

In some embodiments, simultaneously pressing a plurality of buttons of the electronic device controller 610 enables the controller 610 to perform additional functions. For example, in some embodiments, simultaneously pressing two buttons of the controller 610 sends a signal to the remotely located electronic device 630 to take a photo and/or begin recording video. In some embodiments, the controller 610 comprises a light which indicates that the remotely located electronic device 630 is recording a video. In some embodiments, recording can be stopped by simultaneously pressing the same two buttons of the controller 610 to send a signal to the remotely located electronic device 630 to stop recording video.

As shown within FIGS. 5A-5C and FIGS. 6A-6C, the remote control devices and systems 500 and 600 comprise one or more controls for controlling a remotely located electronic device. Particularly, the remote control devices and systems 500 and 600 are able to comprise any appropriately desired control buttons for controlling a remotely located electronic device. Additionally, the buttons are able to be placed within any appropriately desired location and/or orientation on the electronic device controllers. In some embodiments, the electronic device controllers comprise touch screen controls.

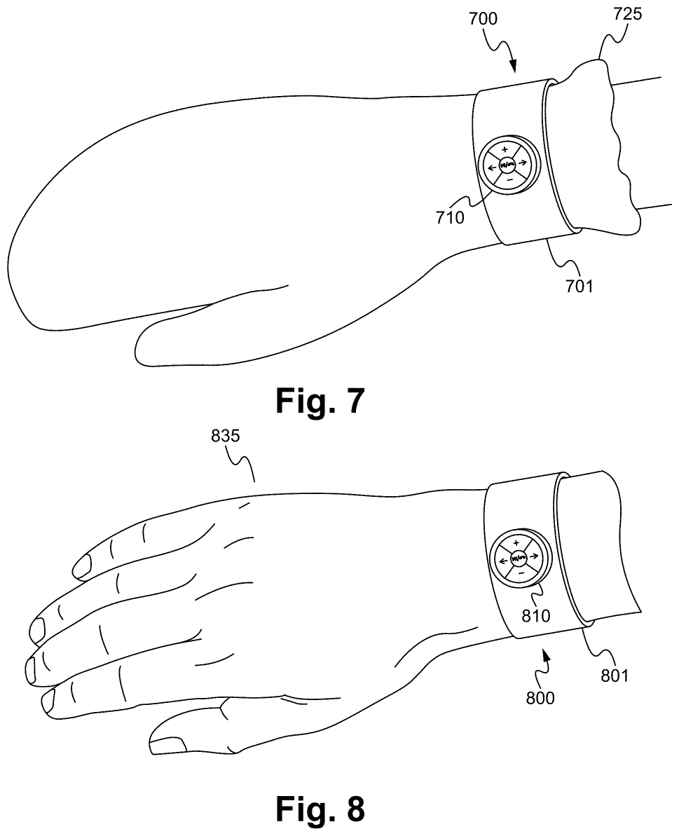

In some embodiments, such as shown within FIG. 7, the band and/or body 701 of the remote control device and system 700 is configured to fit around a glove or mitten 725 of a user. In some embodiments, the band and/or body 701 of the remote control device and system 700 is configured to fit around a jacket or other piece of clothing. Particularly, the band and/or body 701 of the remote control device and system 700 is able to fit around any desired article as appropriately desired. Consequently, the user is able to use the remote control device and system 700 in a cold weather atmosphere to control a remotely located electronic device. For example, the user is able to use the remote control device and system 700 to easily take pictures and/or video, such as described above, without removing their gloves or mitten. In some embodiments, the body 701 is stretchable to stretch around the glove or mitten of a user and then retracts tight against the glove or mitten. In some embodiments, the body 701 continuously wraps around an entire circumference of the glove or mitten and connects by hook and loop material or other appropriately desired fastening mechanism. Alternatively, in some embodiments, the body 701 continuously wraps around an entire circumference of the glove or mitten and is able to be cinched tightly and securely around the glove or mitten by an appropriately desired mechanism. In some embodiments, the body 701 comprises an appropriately desired waterproof and/or wind-proof fabric to protect against the outside elements.

In further embodiments, such as shown in FIG. 8, the band and/or body 801 of the remote control device and system 800 is configured to fit directly around a wrist 835 of a user. In some of these embodiments, the body 801 is able to comprise a mesh absorbent or wicking material. Consequently, the user is able to use the remote control device and system 800 while engaging in activity or in hot weather where the user might encounter perspiration. The band 801 is then able to absorb the perspiration or other moisture and still remain comfortable while being worn by the user. As described above, in some embodiments, the body 801 is stretchable to stretch around the glove or mitten of a user and then retracts tight against the glove or mitten. In some embodiments, the body 801 continuously wraps around an entire circumference of the wrist or arm and connects by a hook and loop material, Velcro®, buttons or other appropriately desired fastening mechanism. Alternatively, in some embodiments, the body 801 continuously wraps around an entire circumference of the wrist or arm and is cinched tightly and securely around the wrist or arm by an appropriately desired mechanism.

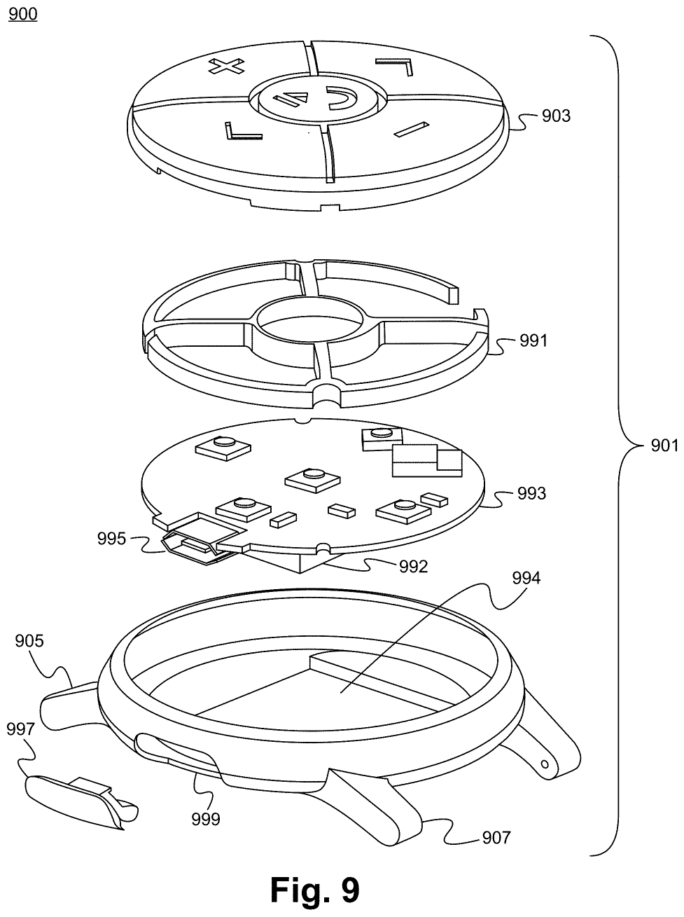

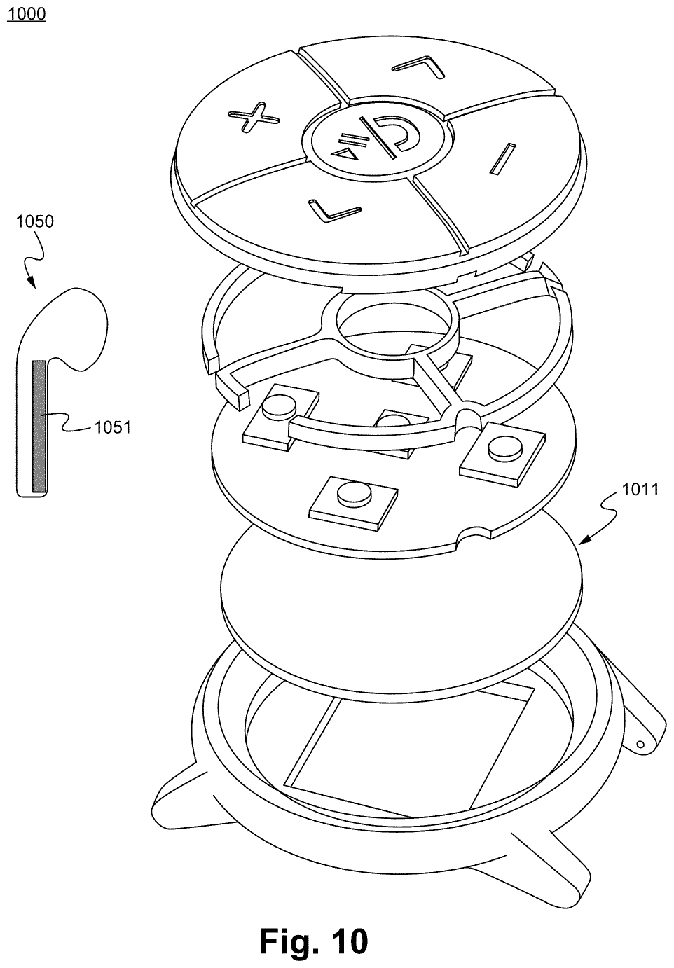

FIG. 9 illustrates an exploded view of a remote control device, such as described above, in accordance with some embodiments. As shown within FIG. 9, the remote control device 900 comprises a substantially circular remote control body 901. In some embodiments, the remote control body 901 comprises a remote control face 903 comprising one or more pressable control buttons for communicating with a remotely located electronic device. As shown in FIG. 9, the remote control device 900 comprises a frame 991 for framing the remote control face 903 and a circuit board 993 comprising one or more internal electronics for controlling the remote control device 900. As shown within FIG. 9, in some embodiments, electronics of the circuit board 993 are embedded into and flush with the circuit board 993 and surround a battery 992 of the remote control device 900. As described above, the body 901 is able to comprise any appropriately desired shape. For example, in some embodiments, the body 901 is square or rectangular shaped.

In some embodiments, the remote control device 900 comprises a charging port 995 for charging the remote control device 900. In some embodiments, the remote control device 900 comprises a cover 997 is removable to access a cutout 999 to access the charging port 995 of the body 901. In some embodiments, the remote control device 900 is charged is using one of a micro-usb and a usb connection. However, the remote control device is able to be charged using any appropriately desired mechanism.

As further shown within FIG. 9, the remote control device 900 comprises a battery 992 which fits within a cutout 994 of the body 901. The battery 992 is specifically designed and configured to fit within the body 901 to enable the body 901 to have a slimmer profile than if a traditional battery were used. Particularly, the battery 992 is slimmer than a traditional watch battery, which enables the remote control device 900 to have a slim and comfortable profile. Additionally, the battery 992 is configured with a greater amount of power than a traditional battery. For example, a traditional watch sized battery is typically 3.2 mm to 5.5 mm high by 20 mm in diameter and is able to generate 6 hours of power. In some embodiments, the battery 992 is 2.5 mm high by 21 mm in diameter and is able to generate 48 hours of power. In some embodiments, the battery 992 is square and is able to withstand temperatures down to negative 20° Fahrenheit and up to positive 140° Fahrenheit.

FIG. 10 illustrates an exploded view of a remote control device, such as described above, in accordance with further embodiments. As shown within FIG. 10, in some embodiments, the remote control device 1000 comprises a layer of electric and electromagnetic radiation (EMF) shielding material 1011. The NEMKO lab tested and certified EMF shielding material 1011 shields EMF radiation generated by the remote control device 900 from the user device. In some embodiments, the remote control device 1000 is used with headphones 1050 comprising NEMKO lab tested and certified EMF shielding material 1051 for shielding EMF radiation generated by the headphones 1050.

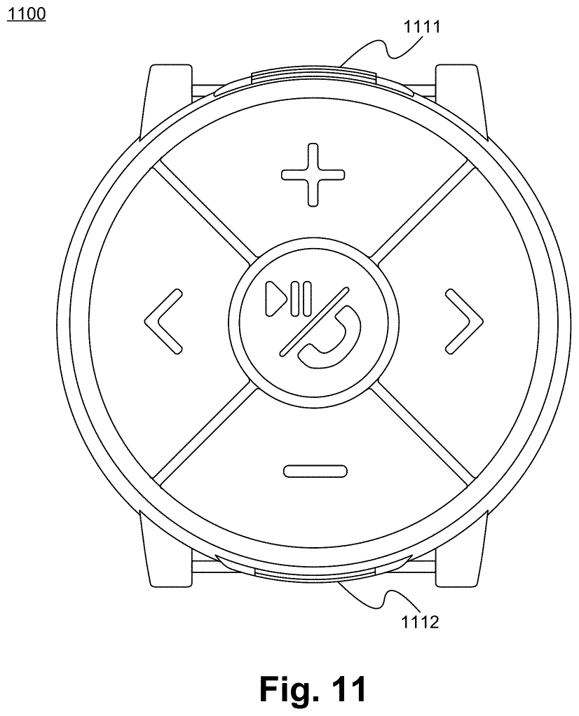

As described above, in some embodiments, simultaneously pressing two buttons of the remote control device sends a signal to the remotely located electronic device to begin recording video. For example, such as shown within FIG. 11, in some embodiments, simultaneously pressing a top button 1111 and a bottom button 1112 of the remote control device 1100 to control a video camera or other device capable of taking video. In this manner, the top button 1111 and a bottom button 1112 are each pressed such as indicated within FIG. 11 to send a signal to the remotely located electronic device to start recording, stop recording, take a still picture and control the video camera or other remotely located electronic device, such as described above.

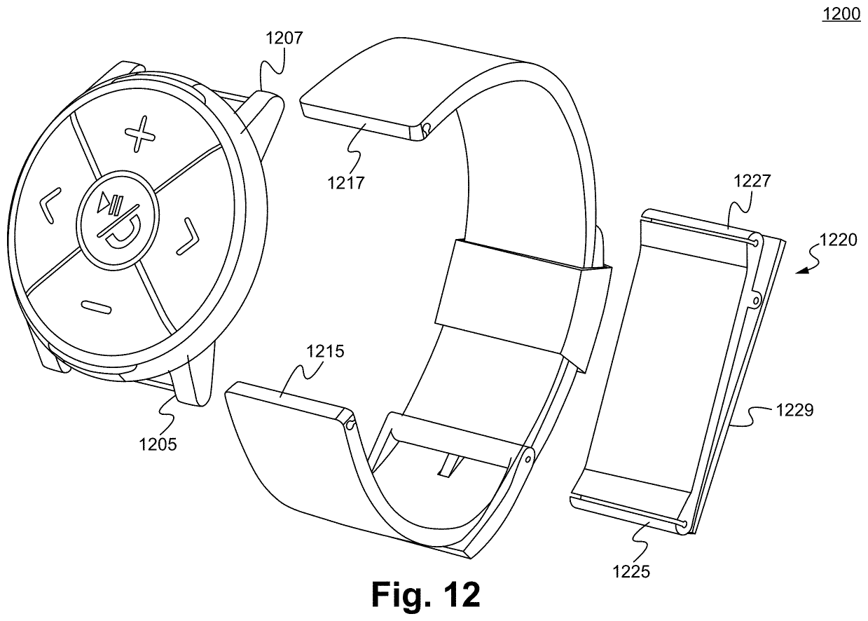

As further described above, and as further shown within FIG. 12, in some embodiments, the remote control device 1200 comprises a left side lug set 1205 for coupling the left side strap 1215 to a left side lug set 1205 of the remote control device 1200 and a right side lug set 1207 for coupling the right side strap 1217 to a right side of the remote control device 1200. Particularly, the remote control device 1200 is able to utilize attachment devices such as a carabineer, a lanyard, a key chain and other appropriately desired attachment devices. For example, such as shown within FIG. 12, in some embodiments, a clip 1229 is able to couple with the remote control device 1200 by coupling a left side attachment 1215 to a left side lug set 1205 of the remote control device 1200 and a right side lug set 1207 for coupling the right side strap 1217 to a right side of the remote control device 1200.

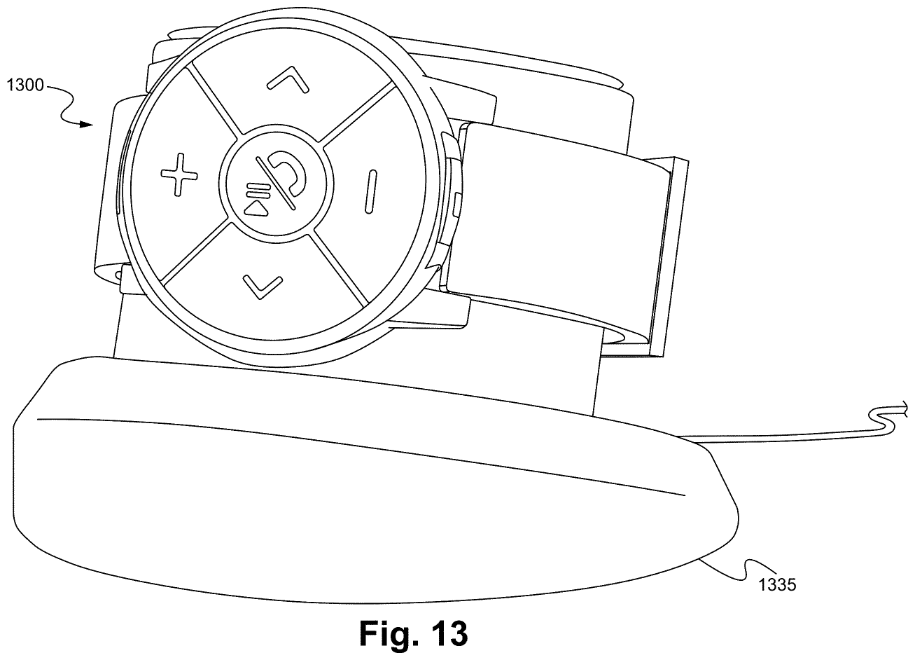

FIG. 13 illustrates a remote control device 1300 coupled to a wireless charging station 1335 for charging the remote control device 1300. As described above, in some embodiments, the remote control device 1300 is able to be charged in a wired manner using one of micro-usb and a usb connection. However, the remote control device 1300 is able to be charged in any appropriately desired wired and wireless manner.

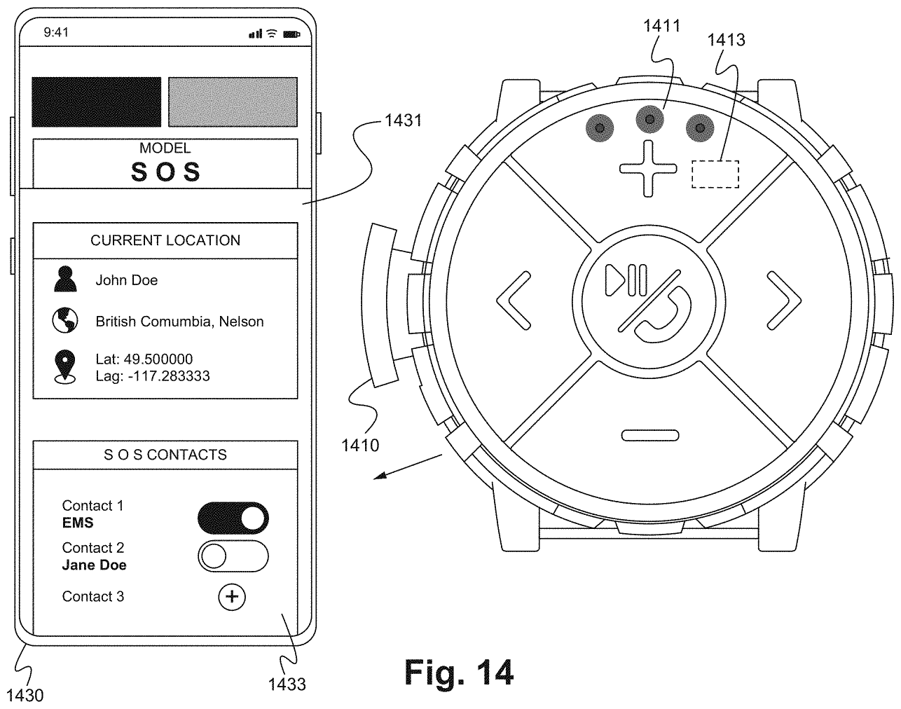

In further embodiments, the remote control device is able to communicate with an application stored on a memory of a remotely controlled device. As shown within FIG. 14, the remote control device 1400 comprises a pullable button 1410 which is pulled outward to send an alert indicating the location of the remote control device 1400 through an application stored on an electronic device 1430. For example, a user is able to enter one or more contacts 1433 into an application and when the pullable button is pulled outward an alert indicating the location of the remote control device 1400 is sent through an application stored on an electronic device 1430 to the one or more entered contacts 1433. In some embodiments, the remote control device 1400 comprises a GPS or GNSS antenna 1413 for sending a location 1431 of the remote control device 1400 through the application stored on the electronic device 1430. In some embodiments, the electronic device 1430 comprises a GPS or GNSS antenna for sending a location through the application stored on the electronic device 1430.

In some embodiments, an alert 1411 is also generated at the remote control device 1400 to indicate that an alert has been sent through the application on the electronic device 1430. Particularly, in some embodiments, a location of the remote control device 1400 and the user can be engaged through the application and one ore more contacts can be designated. In this manner, a SOS alert can be sent to custom contacts such as emergency services, family, friends or other custom contacts by sending a location of the remote control device 1400 through the application. Additionally, although a pullable button 1410 is shown within FIG. 14 to send an alert indicating the location of the remote control device 1400, any appropriately desired pressable and/or pullable button or combination of pressable and/or pullable buttons of the remote control device 1400 is able to be used to send the location signal.

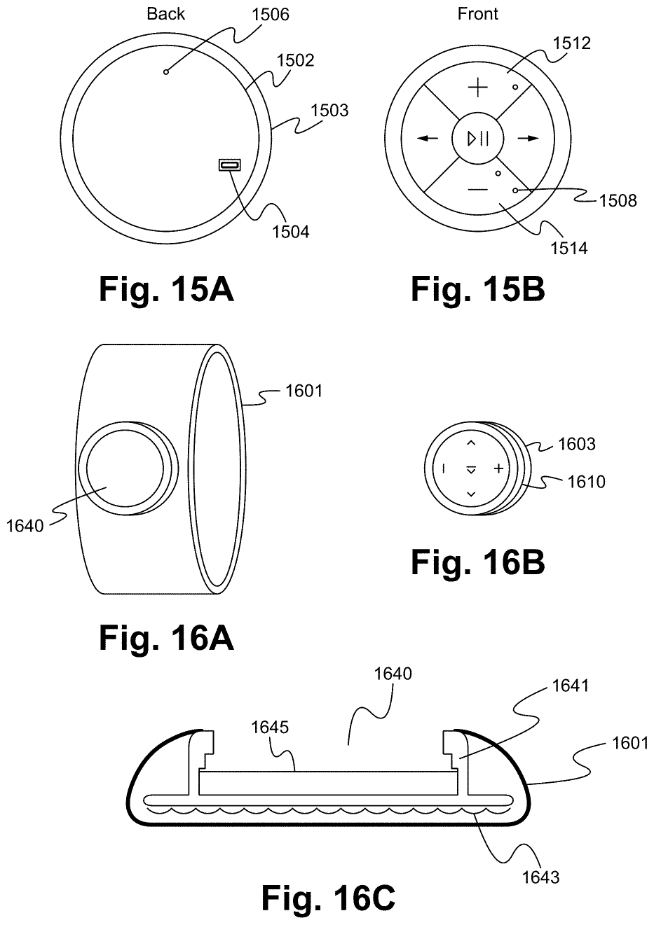

FIGS. 15A and 15B illustrate an electronic device controller, in accordance with some embodiments. FIG. 15A illustrates a back side of the electronic device controller. As shown within FIG. 15A, in some embodiments, the back side 1502 of the electronic device controller shows a wireless connectivity status 1506. In further embodiments, the controller comprises a charging port 1504 for recharging the controller. As described above, the electronic device controller is able to connect to the remotely located electronic device by any appropriately desired wireless method. Additionally, although a charging port 1504 is shown within FIG. 15A in some embodiments, the controller is battery powered. Particularly, the controller is able to be powered by any appropriately desired power method. As further shown in FIG. 15A, in some embodiments, the electronic device controller comprises a lip or ring 1503, which enables the controller to mount to the band, such as described below.

As shown in FIG. 15B, the front sides of the electronic device controller comprise one or more controls for controlling a remotely located electronic device. As described above, the remote control is able to comprise any appropriately desired control buttons for controlling a remotely located electronic device. Additionally, the buttons are able to be placed within any appropriately desired location and/or orientation on the electronic device controller. In some embodiments, the electronic device controller comprises touch screen controls. As described above, the electronic device controller is configured to communicate with and/or control a remotely located electronic device, such as a smart phone, media player, personal video camera or other appropriately desired device. As further shown within FIG. 15B, in some embodiments, the controller comprises a LED light 1508 which stays lit when a video is recording and blinks blue when connecting to the remotely located electronic device. As described above, in some embodiments, simultaneously pressing two buttons of the controller sends a signal to control the remotely located electronic device. For example, in some embodiments, simultaneously pressing two buttons of the controller sends a signal to control the remotely located electronic device to take a photo and/or begin recording video. Additionally, in some embodiments, holding a button, rather than pressing the button sends a signal to control the remotely located electronic device. In some embodiments, holding the button 1512 sends a signal to the electronic device to activate a digital assistant and/or voice commands for the electronic device. For example, holding the button 1512 sends a signal to the electronic device that then enables the user to ask the electronic device a question such as “what is the temperature,” or perform a voice command such as “call dad.” Particularly, the controller is able to be programmed to send any appropriately desired control command to the remotely located electronic device.

As shown within FIGS. 16A and 16B, in some embodiments, the electronic device controller 1610 is shown removably coupled to the body 1601. In some embodiments, the electronic device controller 1610 is able to removably couple with one of a plurality of bodies one at a time, such that the electronic device controller 1610 is configured to separately couple with each of the plurality of bodies. As shown within FIG. 16A, in some embodiments, the electronic device controller 1610 is configured to removably couple with a cavity 1640 of the body 1601. As described above, in some embodiments, the electronic device controller 1610 comprises a lip or ring 1603, which enables the controller 1610 to couple with a lip or ring 1645 of the cavity 1640.

As shown within FIG. 16C, in some embodiments, the cavity 1640 comprises one or more indentation features 1641 which further hold the controller 1610 and enable the controller to sit flush inside the cavity 1640. In some embodiments, the cavity 1640 comprises a silicon mount. In some embodiments, the cavity 1640 couples to an outside of the body 1601 by flexible glue or stitching 1643. However, the cavity 1640 and the controller 1610 are able to couple to the body 1601 by any appropriately desired mechanism as known within the art. In some embodiments, the controller 1610 is able to be embedded within a surface of the body 1601.

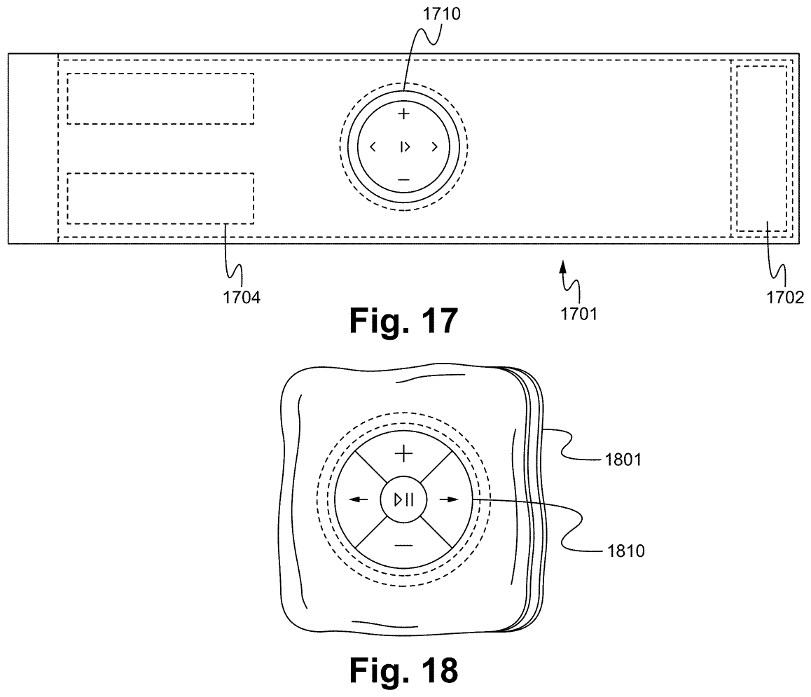

As shown within FIG. 17, in some embodiments, the body 1701 is able to comprise a hook and loop fastening system for attaching two sides of the body 1701 to couple the body 1701 around an appendage of a user. As shown within FIG. 17, the body 1701 comprises a first side 1702 and a second side 1704 comprising a hook and loop fastening system which enables to the body 1701 to be fastened to an appropriate size around the user's appendage. In some embodiments, the body 1701 comprises an appropriately desired waterproof and/or wind-proof fabric to protect against the outside elements. As described above, the controller 1710 is able to couple and/or removably couple with the body using any appropriately desired mechanism as desired.

As shown within FIG. 18, the body 1801 is configured to fit directly around an appendage of a user. As described above, in some of these embodiments, the body 1801 comprises a mesh absorbent or wicking material. The body 1801 is then able to absorb the perspiration or other moisture and still remain comfortable while being worn by the user. As described above, the controller 1810 is able to couple and/or removably couple with the body using any appropriately desired mechanism as desired.

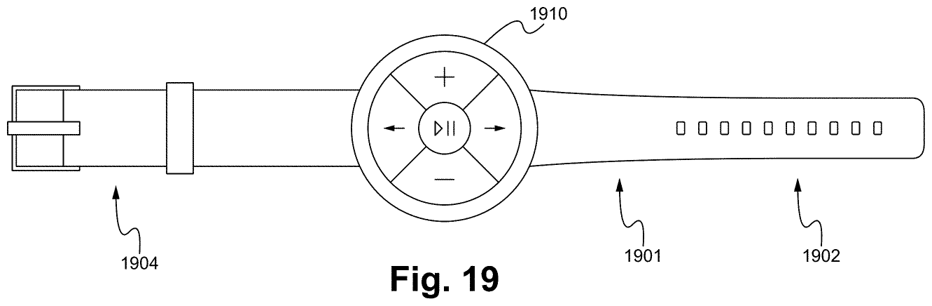

As shown within FIG. 19, in further embodiments, the body 1901 comprises a fastenable band comprising a right side 1902 and a left side 1904. A user is able to fasten the right side 1902 to the left side 1904 at an appropriate size around the user's appendage. In some embodiments, the body 1901 comprises a cavity, such as described above so that the controller 1910 is able to removably couple to the body 1901.

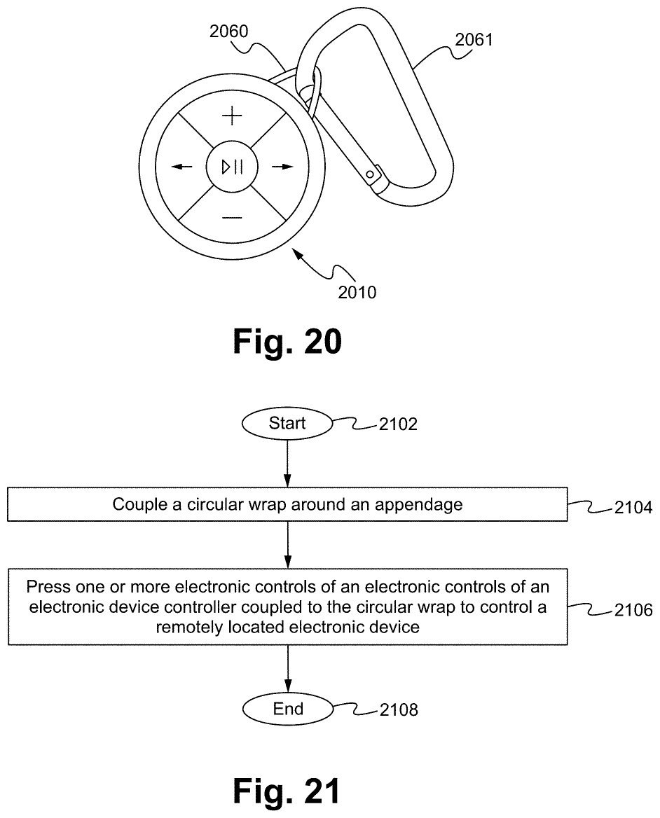

In some embodiments, such as shown within FIG. 20, the controller 2010 is configured to couple with an attachment. For example, in some embodiments the controller 2010 comprises a loop 2060 or other mechanism which enables the body 2010 to couple with an attachment such as a carabineer 2061. Using the carabineer 2061, the controller 2010 is able to be attached to other objects and in a convenient place where it is able to be used to control an electronic device, such as described above. Particularly, the controller 2010 can be used with other appropriately desired attachment devices such as a lanyard, a key chain and other appropriately desired attachment devices.

FIG. 21 illustrates a method of utilizing a remote control in accordance to some embodiments. In some embodiments, the remote control comprises an electronic device controller, such as described above. The method begins in the step 2102. In the step 2104, a circular wrap is coupled with an appendage of a user such that the circular wrap continuously wraps around an entire circumference of the appendage of the user. Then, in the step 2106, one or more electronic controls of an electronic device controller coupled to the circular wrap are pressed to control a remotely located electronic device. The method ends at the step 2108.

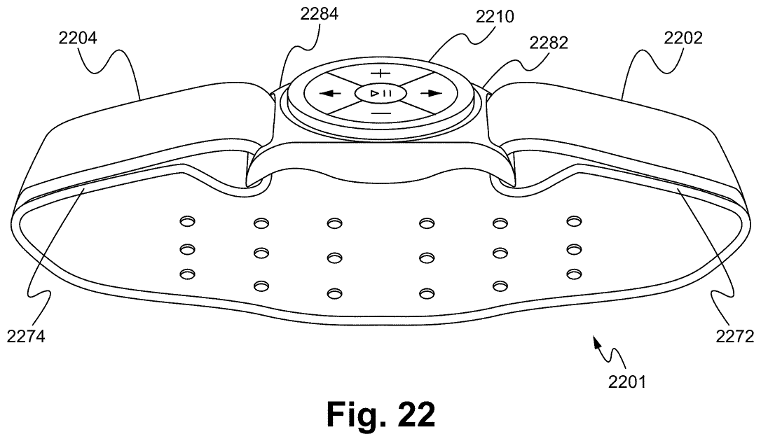

As further shown within FIG. 22, in some embodiments, the body 2201 comprises a band comprising a right side 2202 and a left side 2204. A user is able to loop the right side 2202 through a lug 2282 of the controller 2210 to fasten the right side 2202 to a section 2272 of the right side 2202. In some embodiments, the right side 2202 is fastened to the section 2272 using hook and loop material or other appropriately desired fastening mechanism. Similarly, a user is able to loop the left side 2204 through a lug 2284 of the controller 2210 to fasten the left side 2204 to a section 2274 of the left side 2204. In some embodiments, the right side 2204 is fastened to the section 2274 using hook and loop material or other appropriately desired fastening mechanism. In some embodiments, the body 2201 comprises a cavity, such as described above so that the controller 2210 is able to removably couple to the body 2201.

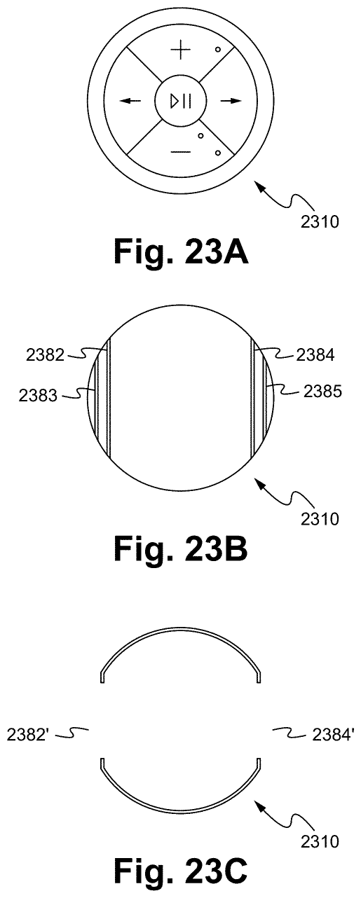

FIG. 23A illustrate the controller, such as described above, in accordance with further embodiments. FIG. 23A illustrates a front sides of the electronic device controller 2310 comprising one or more controls for controlling a remotely located electronic device. As described above, the remote control is able to comprise any appropriately desired control buttons for controlling a remotely located electronic device. Additionally, the buttons are able to be placed within any appropriately desired location and/or orientation on the electronic device controller. In some embodiments, the electronic device controller comprises touch screen controls. As described above, the electronic device controller is configured to communicate with and/or control a remotely located electronic device, such as a smart phone, media player, personal video camera or other appropriately desired device. In some embodiments, such as shown within FIG. 23A, the controller 2310 is between 6.25 mm and 6.75 mm thick. However, the controller 2310 is able to comprise any appropriately desired dimensions.

FIG. 23B illustrates a back side of the controller 2310 such as described above. In some embodiments, the lugs 2382 and 2383 and 2384 and 2385 are spaced 3 mm apart and configured to accept a strap and/or a body, such as described above that is 23 mm wide. In some embodiments, the strap and/or body, such as described above comprises hook and loop material.

As shown in FIG. 23C, in some embodiments, a right lug 2382′ and a left lug 2384′ of the controller 2310 are configured to accept a fastenable band, such as described above. In some embodiments, a face of the controller is able to be up to 46 mm wide.

In use, a wearable remote control device for communicating with a remotely located electronic device comprises one or more electronic controls for controlling the remotely located electronic device. The remote control device is able to be used to control a smart phone, media player, personal video camera or other appropriately desired electronic device. In some embodiments, one or more tactile buttons of the remote control device are easily pressable to control the remotely located electronic device. In some embodiments, a strap secures the wearable remote control device to an appendage of a user for easy access. As such, the remote control device and system such as described herein has many advantages.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A wearable remote control device for communicating with a remotely located electronic device, the remote control device comprising:
a. a substantially circular remote control body comprising:
i. a remote control face comprising:
i. a first pressable control button located within a center of the body; and
ii. one or more additional pressable control buttons arranged in a circle around an outside of the first pressable button; and
b. an attachment mechanism for removably coupling the remote control device with an appendage of a user.

2. The wearable remote control device of claim 1, wherein the attachment mechanism comprises a strap for securing the wearable remote control device to the appendage of a user.

3. The wearable remote control device of claim 1, wherein the attachment mechanism comprises a wearable body comprising a cavity for removably receiving the remote control body.

4. The wearable remote control device of claim 1, wherein the attachment mechanism comprises one of a carabineer, a lanyard, a key ring and a clip.

5. The wearable remote control device of claim 1, wherein the first pressable button and the one or more additional pressable buttons each comprise separately pressable mechanical buttons.

6. The wearable remote control device of claim 1, wherein the remotely located electronic device comprises one or more of a smart phone, a media player, a video camera, and a set of earphones.

7. The wearable remote control device of claim 1, wherein the first pressable button and the one or more additional pressable buttons comprise one or more of a start/pause control, a volume control and a track control.

8. The wearable remote control device of claim 1, wherein one or more of the first pressable button and the one or more additional pressable buttons send a signal to the remotely located electronic device to take a picture, start and stop recording video.

9. The wearable remote control device of claim 1, wherein one or more of the first pressable button and the one or more additional pressable buttons answers and terminates a phone call from the remotely located electronic device.

10. The wearable remote control device of claim 1, wherein one or more of the first pressable button and the one or more additional pressable buttons communicate with an application stored on a memory of the remotely located electronic device.

11. The wearable remote control device of claim 1, comprising a pullable button that activates an alert which sends a location from the application stored on a memory of the remotely located electronic device indicating a location of the wearable remote control device.

12. The wearable remote control device of claim 1, wherein one or more of the first pressable button and the one or more additional pressable buttons is pressed and held to activate a microphone for receiving voice commands.

13. The wearable remote control device of claim 1, wherein one or more of the first pressable button and the one or more additional pressable buttons is pressed to activate a virtual assistant connected to the remotely located electronic device.

14. The wearable remote control device of claim 1, wherein the device is charged using one of a micro-usb cable and a usb cable.

15. The wearable remote control device of claim 1, wherein the remote control device is wirelessly charged.

16. The wearable remote control device of claim 1, wherein the remote control device comprises a battery with a thickness of 2.5 mm or less.

17. The wearable remote control device of claim 1, wherein one or more electronic components of a circuit board of the remote control device are embedded into and flush with the circuit board and surround the battery of the remote control device.

18. The wearable remote control device of claim 1, wherein the remote control device comprises a layer of electric and electromagnetic radiation shielding.

19. The wearable remote control device of claim 1, wherein the remote control device is usable with headphones comprising a layer of electric and electromagnetic radiation shielding.

20. A wearable system for communicating with a remotely located electronic device comprising:
a. a substantially circular body comprising:
i. a first pressable control button located within a center of the body; and
ii. one or more additional pressable control buttons arranged in a circle around an outside of the first pressable button, wherein one or more of the first pressable button and the one or more additional pressable buttons communicate with an application stored on a memory of the remotely located electronic device; and
iii. a microphone for receiving voice commands for sending a voice command to the remotely located electronic device;
b. a left side strap coupled to the body; and
c. a right side strap coupled to the body, wherein the left side strap and the right side strap fasten to couple the system with an appendage of a user.

21. The wearable system of claim 20, wherein the first pressable button and the one or more additional pressable buttons each comprise separately pressable mechanical buttons.

22. The wearable system of claim 20, wherein the remotely located electronic device comprises one or more of a smart phone, a media player, a video camera, and a set of earphones.

23. The wearable system of claim 20, wherein the first pressable button and the one or more additional pressable buttons comprise one or more of a start/pause control, a volume control and a track control.

24. The wearable system of claim 20, wherein one or more of the first pressable button and the one or more additional pressable buttons send a signal to the remotely located electronic device to take a picture, start and stop recording video.

25. The wearable system of claim 20, wherein one or more of the first pressable button and the one or more additional pressable buttons answers and terminates a phone call from the remotely located electronic device.

26. The wearable system of claim 20, comprising a pullable button that activates an alert which sends a location from the application stored on a memory of the remotely located electronic device indicating a location of the wearable remote control device.

27. The wearable system of claim 20, wherein one or more of the first pressable button and the one or more additional pressable buttons is pressed and held to activate the microphone for receiving voice commands.

28. The wearable system of claim 20, wherein one or more of the first pressable button and the one or more additional pressable buttons is pressed to activate a virtual assistant connected to the remotely located electronic device.

29. A method of utilizing a wearable remote control device for communicating with a remotely located electronic device, the method comprising:
a. attaching a left side strap to a substantially circular body of the wearable remote control device;
b. attaching a right side strap to the substantially circular body of the wearable remote control device; and
c. coupling the wearable remote control device with an appendage of a user;
d. pressing one or more tactile control buttons of the body to communicate with an application stored on a memory of the remotely located electronic device.

30. The method of claim 29, wherein the remotely located electronic device comprises one or more of a smart phone, a media player, a video camera and a set of earphones.

31. The method of claim 29, wherein the one or more tactile control buttons comprise one or more of a start/pause control, a volume control and a track control.

32. The method of claim 29, wherein the one or more tactile control buttons send a signal to the remotely located electronic device to take a picture, start and stop recording video.

33. The method of claim 29, wherein pressing one or the one or more tactile control buttons activates a microphone for receiving voice commands.

34. A wearable remote control device for communicating with a remotely located electronic device, the remote control device comprising:
a. a control body comprising:
i. a remote control face comprising:
i. a plurality of pressable buttons;
ii. a battery comprising a thickness of less than or equal to 2.5 mm; and
iii. a circuit board comprising one or more electronic components embedded into and flush with the circuit board and that surround the battery.

35. The wearable remote control device of claim 34, wherein the remote control device comprises a layer of electric and electromagnetic radiation shielding.

36. The wearable remote control device of claim 34, wherein one or more of the plurality of pressable buttons communicates with an application stored on a memory of the remotely located electronic device.

37. The wearable remote control device of claim 34, comprising a pullable button that activates an alert which sends a location from the application stored on a memory of the remotely located electronic device indicating a location of the wearable remote control device.
